(19) United States
(12) Patent Application Publication
(10) Pub. No.: US 2004/0217063 A1
(43) Pub. Date: Nov. 4, 2004

(54) Cellodextrin production by mixed acid hydrolysis and chromographic separation

(76) Inventors: Yiheng Zhang, Hanover, NH (US); Lee R. Lynd, Meriden, NH (US)

Correspondence Address: LATHROP & GAGE LC, 4845 PEARL EAST CIRCLE, SUITE 300, BOULDER, CO, 80301, US

(21) Appl. No.: 10/835,125

(22) Filed: Apr. 29, 2004

Related U.S. Application Data
(60) Provisional application No. 60/467,036, filed on May 1, 2003.

(51) Int. Cl. C02F 1/52

(52) U.S. Cl. 210/723

(57) ABSTRACT

Cellodextrins are made by cellulose hydrolysis using mixed concentrated hydrochloric acid and sulfuric acid. Cellulose is rapidly and completely dissolved to produce a high cellodextrin yield. Acetone is used as an efficient organic solvent for precipitating cellodextrins from the mixed acid hydrolyzate. Cellodextrins are resuspended in water and separated with high productivity using ion exchange.

### CROSS REFERENCE TO RELATED APPLICATIONS

This application claims priority to U.S. Provisional Application Ser. No. 60/467,036, filed May 1, 2003 and incorporated herein by reference.

### BACKGROUND OF THE INVENTION

Cellodextrins or β-1,4-glucose oligomers may be derived from cellulose by acid hydrolysis. Cellodextrins play a key role in cellulase synthesis regulation, as reported by Bhat et al; Cellobiose: a true inducer of cellulosome in different strains of Clostridium thermocellum, FEMS Microbiol. Lett.(1993); and Spiridonov et al., Regulation of biosynthesis of individual cellulases in Thermomonospora fusca, J. Bacteriol.180: 3549-3552 (1998). Cellodextrins are involved in cellulase hydrolysis, as demonstrated by cellulase investigations reported by Rouvinen et al., Three dimensional structure of cellobiohydrolase II from Trichoderma reesi, Science 249:380-385 (1990); Guimaraes et al., The crystal structure of catalytic mechanism of cellobiohydrolase CeIS, the major enzymatic component of the Clostridium thermocellum cellulosome, J. Mol. Biol. 320: 587 (2002); Hsu et al., Kinetics studies of cellodextrins hydrolyses by exocelluluase from Trichoderma reesei, Biotechnol. Bioeng. 22: 2305-2320 (1980); Halliwell et al., The action on cellulose and its derivates of a purified 1,4-β-glucanase from Trichoderma koningii, Biochem. J. 199: 409-417 (1981); and Fauth et al., Puification and characterization of endoglucnase Ss from Clostridium thermocellum, Biochem. J. 279: 67-73 (1991).

Cellulolytic microorganisms metablolize cellodextrins, for example, in growth and bioenergetics, as reported by Freer et al., Direct fermentation of cellodextrins to ethanol by Candida wickerhamii and C. lusitaniae, Biotechnol. Lett. 4: 453-458 (1982); Freer et al., Characterization of cellobiose fermentations to ethanol by yeasts, Biotechnol. Bioeng. 25 541-557 (1983); Russell, Fermentation of cellodextrins by cellulolytic and noncellulolytic rumen bacteria, Appl. Environ. Microbiol. 49: 572-576 (1985); Lou et al., Cellobiose and cellodextrin metabolism by the ruminal bacterium Ruminococcus albus, Curr. Microbiol.35: 221-227 (1997); Lynd et al., Microbial cellulose utilization: fundamentals and Biotechnology, Microbiol. Mole. Biol. Rev. 66: 506-577 (2002); Shi et al., Utilization of individual cellodextrins by three predominant ruminal cellulolytic bacteria, Appl. Envrion. Microbiol. 62: 1084-1088 (1996); and Lynd et al. Quantitative determination of cellulase concentration as distinct from cell concentration in studies of microbial cellulose utilization: Analytical framework and methodological approach, Biotechnol. Bioeng. 77: 467-475 (2002). Cellodextrins may also be used in strain screening procedures, as reported by Freer et al. (1983).

Cellodextrins are beneficial to human health by reducing cholesterol, as well as preventing diabetes and obesity, as reported by Wakabayashi et al., Effect of indigestive dextrin on glucose tolerance in rats, J. Endocrinology.144: 533-538 (1995), and Cummings et al., Role of intestinal bacteria in nutrient metabolism. Clinic Nutr.16: 3-11 (1997).

High prices and low production yields of cellodextrins currently prohibit widespread use of cellodextrins. Current prices for cellodextrins G₃ to G5 range from about $8 to $15 per mg, while dosages of cellodextrins required for health care uses require the consumption of several grams per day. These high prices preclude the availablility of cellodextrins to many persons who might benefit from consuming cellodextrins.

Three methods are used to produce cellodextrins. The methods each use cellulose as a starting point. Reaction is by:

Fuming HCL, as shown by Miller et al., A study of methods for preparation oligosaccharidesfrom cellulose, Arch. Biochem. Biophy. 91: 21-26 (1960) and Miller., Cellodextrins, Methods in Carbohydrate Chemistry 3: 134-139 (1963),

H₂SO₄, as discussed by Voloch et al., Preparation of cellodextrins using sulfuric acid, Biotechnol. Bioeng.26: 557-559 (1984), and

acetolysis-deacetylation, shown by Dickey et al., A polymer-homologous series of sugar acetates from the acetolysis of cellulose, J. Am. Chem. Soc.71: 825-828 (1949); and Wolfram et al., The polymer-homogous series of oligosacchardies from cellulose, J. Am. Chem. Soc. 74: 5331-5333 (1952), and Schmid et al., Preparation of cellodextrins and isolation of oligomeric side components and their characterization., Anal. Biochem. 175: 573-583 (1988).

The most frequently used method is the fuming HCL method reported by Miller (1963). Cellodextrins are hydrolyzed by contact with fuming HCL, and then are separated into individual component fractions using a charcoal-celite column. The Miller (1963) method has been modified by some researchers. For example, vacuum may be used to remove excess HCl and reduce NaHCO₃ consumption, as reported by Dawson et al., Cellobiose and cellodextrin metabolism by the ruminal bacterium Rum inococcus albus, Curr. Microbiol.35: 221-227 (1997). An ion-exchange resin to remove residual salts, as shown by Huebner et al., Preparation of cellodextrin: an engineering approach, Biotechnol. Bioeng. 20: 1669-1677 (1978). Another modification utilized by Lou et al., Cellobiose and cellodextrin metabolism by the ruminal bacterium Ruminococcus albus, Curr. Microbiol.35: 221-227 (1997) includes elimination of an acid neutralization step by precipitating cellodextrins by adding an organic solvent to the hydrolyzate, as reported by Freer et al. (1982); Shi et al., Utilization of individual cellodextrins by three predominant ruminal cellulolytic bacteria, Appl. Envrion. Microbiol. 62: 1084-1088 (1996); .Dawson et al., Cellobiose and cellodextrin metabolism by the ruminal bacterium Ruminococcus albus, Curr. Microbiol.35: 221-227 (1997); Schmid et al.(1988); and Voloch et al. (1984).

Because fuming HCl is a very toxic and highly volatile acid, and its concentration is uncertain, all equipment, tubing and connectors should used under a hood and be erosion-proof. Although Miller (1963) reported to gross G3-G7 yield as high as 25%, the Miller process, as well as related process improvements, generally produce yields from 5-10% of the theoretical maximum.

The other techniques are less often utilized. The use of sulfuric acid, as shown by Voloch et al. (1984), includes using 80% sulfuric acid for primary hydrolysis, and then diluting the acid for secondary hydrolysis. The cellodextrin yield by H₂SO₄ is reported to be as low as ˜2% after ethanol precipitation and activated carbon de-coloration. Deleterious sulfated derivatives can be formed, and the sulfuric acid has a tendency to oxidize the cellodextrins. Therefore, the H₂SO₄ hydrolysis method is not often used. Cellodextrin preparation via acetylation of cellulose is much more expensive and time consuming than the other two processes.

The foregoing techniques merely result in the production of mixed cellodextrins, which require separation to yield isolated compositions in high purity. Prior separation techniques, including Miller (1963), use a charcoal-celite column to adsorb cellodextrins, which are washed into individual cellodextrin fractions by gradient elution with ethanol and water. This separation technique has several shortcomings. Once used, the charcoal-celite column requires repacking to obtain good separation. Low solubility of cellodextrin in the ethanol-water phase submitted to the charcoal-celite column limits cellodextrin concentration in the eluted fractions and impedes separation, especially for the higher oligosaccharides. Excessive time is required for separation to occur. For example, four days may be required for the separation of cellodextrins. The presence of ethanol in the eluent causes difficulty when attempting to freeze-dry the eluted fractions.

Attempts to improve the Miller (1963) process have included size exclusion chromatography using such media as Bio-Gel P2 or P4 gel for separating oligo-saccharides, as reported by G. Schmid et al. (1988); Hamacher et al., Structural heterogeneity of cellooligomers homogeneous according to high-resolution size-exclusion chromatography, J. Chromatogr. 319: 311-318 (1985); Schmidt et al., Gel Chromatography of oligosaccharides up to DP 60, J. Chromatogr.247: 281-288 (1982), and Dellweg et al., Chromatographuc separation of oligosaccharides, Seperation Purification. Method. 2: 231-257 (1973). Catron exchange resins including Bio-Rad AG50W-X4 have been used to separate cellodextrins, as reported by Huebner et al., Preparation of cellodextrin: an engineering approach, Biotechnol. Bioeng. 20: 1669-1677 (1978); Voloch et al. (1984); and Ladisch et al., High-speed liquid chromatography of cellodextrins and other saccharide mixtures using water as the eluent, J. Chromatoghaphyl47: 185-193 (1978).

Difficulties arise when using ion exchange resins to purify cellodextrins, primarily because the cellulose hydrolysis occurs under particularly harsh acidic conditions. During the preparation of acid-free cellodextrin mixtures, according to the process described by Miller (1963), it is desirable to remove the acids without producing large amounts of acid-neutralization byproducts, such as NaCl when NaHCO₃ is used to neutralize the acids. Large amounts of salt cause difficulties in cellodextrin separation, as discussed by Ladisch et al. (1978). Ion-exchange to remove massive quantities of salt is impractical for at least two reasons, namely, excessive adsorption of cellodextrins by anion exchange resin, and the generation of side components as discussed in Huebner et al. (1978). Alternatives to the use of salt-forming additives include stripping partial HCl by vacuum (Huebner et al., (1978) requiring condensation and trapping of HCl vapor, and precipitating cellodextrins by adding organic solvents. See Freer et al. (198)₂; and Schmid et al. (1988). Direct precipitation of cellodextrins by ethanol and propanol may result in the formation of cellodextrin glycosides, as reported by Schmid et al. (1988) and Schmid (1988).

Despite these continuing developments in processes for the manufacture and separation of cellodextrins, process yields remain low and cellodextrin prices remain high. There is a continuing need for process improvements that produce cellodextrins in higher yield and at lower cost.

### SUMMARY

There will now be shown a system and method that overcome the problems outlined above and advance the art by producing cellodextrins in higher yield and at lower cost. By these instrumentalities, purified oligosaccharides may, for example, be produced and sold at prices representing a small fraction of current prices for commercially available cello-oligosaccharides.

In one embodiment, cellodextrins are purified and/or isolated by dissolving cellulose with a mixture of acids that includes hydrochloric acid and sulfuric acid. A cellodextrin-containing hydrolyzate solution is formed. An organic solvent is mixed with to the hydrolyzate solution to precipitate the cellodextrins.

Optional aspects of the mixture of acids include the use of concentrated hydrochloric acid and concentrated sulfuric acid. The concentrated acids may be mixed in a volumetric ratio ranging from 3:1 to 5:1 hydrochloric acid to sulfuric acid. A ratio of 4:1 is, for example, a preferred ratio for many applications. The use of mixed acids speeds hydrolysis, and mixtures at these ratios prevent or reduce deleterious oxidation of cellodextrins by the action of sulfuric acid. The ratio of mixed acids may be adjusted depending upon the type of cellulose and the temperature of reaction. The mixture of acids used to dissolve cellulose may be provided in concentrations that are effective for dissolving at least 0.1 mg cellulose per mL of the mixture of acids, e.g., over a four to six hour hydrolysis time.

The organic solvent used to precipitate the cellodextrins is, for example, an alcohol or ketone of low polarity. Suitable alcohols include, for example, ethanol and propanol. Longer chain alcohols having a carbon number ranging from 3 to 6 may provide higher yield. Acetone is a particularly useful ketone. Precipitation yields are higher with use of acetone, partly because acetone is less polar than the short-chain alcohols.

A purified mixture of cellodextrins may be isolated by filtration or centrifugation of the mixed acid solution after the organic solvent has been added to precipitate the cellodextrins. Filtration or centrifugation removes or separates the cellodextrins from acids in liquid phase and results in the formation of a filter cake or pellet, depending upon the method employed. Additional organic solvent may be used to wash the filter cake or pellet to remove residual acids.

The filter cake or pellet containing the mixture of cellodextrins may be resuspended in a solvent, such as water. Additional amounts of water result in increased quantities of longer chain cellodextrins being solubilized. The aqueous mixture of cellodexrins and water may be purified by ion exchange to eliminate residual chlorine, sulfate, and other impurities.

Anion or cation exchange resins may be used to purify the resuspended cellodextrin solution. Due to the use of sulfuric acid in the mixture of acids, it is difficult to achieve neutral pH by solvent washes because some insoluble cello-oligomer sulfates form during acidification. The cello-oligomer sulfates have a strongly acidic character due to the presence of SO₃H groups. Cellodextrin sulfates are unstable and susceptible to a fast autohydrolytic chain degradation with a splitting off of the half ester, as reported by Klemm et al., Comprehensive Cellulose Chemistry 2: Functionalization of Cellulose, Wiley VCH, Weinheim (1998). By adding a pretreatment of Ba(OH)₂ to the resuspended cellodextrins, some sulfate is removed to form a precipitate of BaSO₄. Alternatively, BaCl may be added into mixed cellodextrin solution to precipitate sulfate completely. Because ion exchange resins have a relatively strong ability to adsorb cellodextrins, especially the shorter cellodextrins, the ion exchange resin is optionally pre-saturated with cellobiose and cellodextrin solution to prevent significant loss of cellodextrins. Detection of whether a significant amount of chloride remains in the mixed cellodextrin solution after ion exchange is accomplished, for example, by adding some AgNO₃ to an aliquot of solution. Finally, the nearly pure mixed cellodextrin solution can be obtained by filtration and ion exchange to remove chlorides.

Anion exchange is particularly useful in removing residual Cl⁻ and SO₄²⁻. A strong anion exchange resin may be utilized to remove chloride and partial free sulfate. The anion exchange resin is optionally used in series, for example, with a size exclusion chromatography column. Either the cation or anion exchange resins may be followed by a size exclusion column to fractionate the cellodextrins by size exclusion chromatography.

In particular embodiments using selected size exclusion resins, the cation exchange resin Bio-Rad AG50WX4 (Ca²⁺) demonstrated a higher separation efficiency than did Bio-Rad P4. Bio-Rad AG50WX4 (Ca²⁺) also had a much higher flowing rate. Bio-Rad AG50WX4 (Ca²⁺) exhibited a somewhat higher separation efficiency for cellodextrins as compared to Bio-Rad P4, and had a much higher allowable flow rate. Almost all of the system pressure drop (95%) was in the P4 column. The overall productivity of separation using Efforts to obtain satisfactory separation with single columns containing AG50WX4 with lengths of either 0.3 m or 1.0 m were unsuccessful, although it might be possible to obtain good results with a 1 m column using a high-pressure pump to load the column. A single ion exchange resin may be used, as opposed to a two stage process using different resins.

### BRIEF DESCRIPTION OF THE DRAWINGS

FIG. 1 is a process schematic diagram showing one method of producing and purifying a mixture of acid-free soluble cellodextrins;

FIG. 2 shows equipment that can be used to purify mixed cellodextrins derived from the process of FIG. 1 by separating the mixed cellodextrins into component fractions by cellodextrin type;

FIG. 3 shows experimental results including the concentration profiles of cellodextrin formation by mixed acid hydrolysis over time;

FIG. 4 shows experimental results including combined cellodextrin yields and reduction of cellulose content by mixed acid hydrolysis over time;

FIG. 5 is a size exclusion chromatogaphy profile showing retention times for various cellodextrins denoted by degree of polymerization, where cellodextrin concentrations are measured by HPLC; and

FIG. 6 shows an elution profile similar to that of FIG. 6, except the peaks are confirmed by signal voltage in the eluent; and

FIG. 7 shows the effect of various organic solvents on precipitation after mixed acid hydrolysis.

### DETAILED DESCRIPTION

There will now be shown and described a system and method of producing and separating cellodextrins by using a mixed acid solution to hydrolyze cellulose and an organic solvent to precipitate the cellodextrins from the mixed acid hydrolyzate solution. The precipitated cellodextrins may be separated from the mixed acid hydrolyzate solution and resuspended in water for further purification to remove residual acid components. The following discussion teaches by way of example, not by limitation, and should not be unduly used to limit the scope of the invention.

As shown below to illustrate a specific embodiment of the broader concepts disclosed, mixed acids containing 80% (v/v) concentrated HCl (˜37% aq) and 20% (v/v) concentrated H₂SO₄ (˜98% aq) may be used to hydrolyze cellulose. An organic solvent may be used to precipitate the cellodextrins from the harsh mixed acid solution, and the precipitate is removed from the solution. The precipitate is optionally washed, resuspended in water, and further purified using a series of columns, such as a Bio-Rad AG50W-X4 cation exchange resin (29 cm long) followed by size exclusion chromatography using Bio-Rad P4 (91 cm long).

The method using hydrolysis by mixed acids and organic solvents to precipitate cellodextrins may offer high yields of purified cellodextrins and high throughput or productivity from the equipment. Longer cellodextrins may be selectively obtained, e.g., those having degrees of polymerization (DP) from 6-9, by varying the concentration of water used to resuspend cellodextrins after they are precipitated. Process equipment is simplified, as the equipment does not necessarily include that required for use of fuming HCL. Reaction conditions more easily controlled than in the case of the Miller (1963) process, and results are highly repeatable.

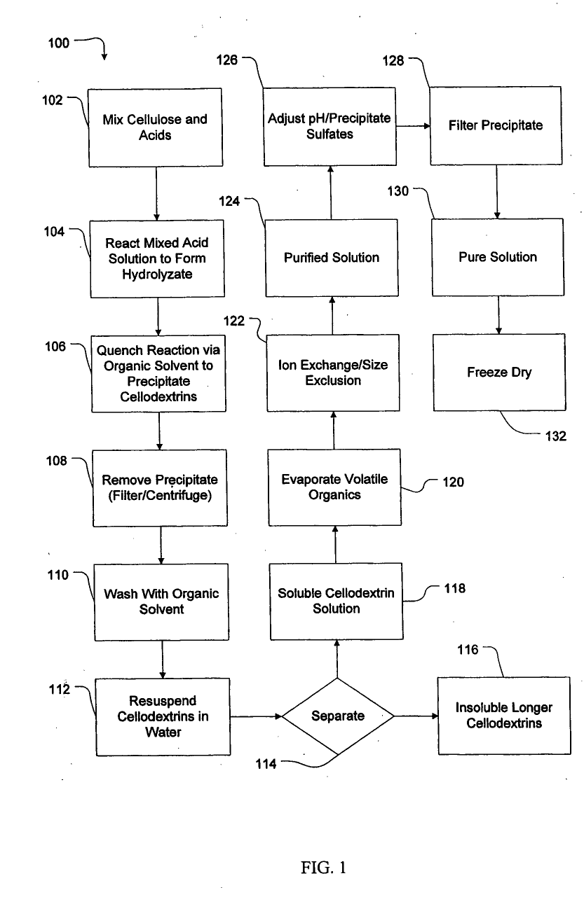

FIG. 1 is a schematic diagram representing one process 100 for making cellodextrins. Mixing 102 occurs as a mixture of cellulose and acids including HCl and H₂SO₄. Reaction kinetics are speeded and process yields are enhanced by the use of concentrated HCl and H₂SO₄. HCl dissolves in water up to a 1:3 mole ratio. Commercial grades of concentrated HCl are often referred to as being 36% to 38% w/w aqueous solutions. Concentrated H₂SO₄ is usually around 98% H₂SO₄ with about 2% water. Lower concentrations of acid may be used, such as aqueous solutions at 25%, 50%, or 75% of the concentrated strength; however, reaction kinetics and yield recoveries favor the use of concentrated solutions. The preferred ratio of concentrated HCl to concentrated H₂SO₄ is 4:1 (v/v); however, other ratios may be used including, for example, ratios ranging from 3:1 to 5:1. Cellulose is preferably mixed with the mixture of concentrated acids at a preferred ratio of 0.1 mg cellulose per ml of mixed acid; however, any other ratio may be used, particularly any ratio that is capable of forming a suspension when the cellulose is provided in powdered form. Alternatively, acids may be cycled through a leach heap of cellulosic feedstock or other cellulose sources.

The mixture is reacted 104 for a period of time sufficient to permit the formation of cellodextrins. In cases where the mixture is a suspension of cellulose in concentrated mixed acids, and the reaction occurs at room temperature, this period of time is preferably from 4 to 6 hours. Completion of the reaction is indicated by a deep yellow or yellow-tan coloration.

The reaction is quenched 106 by diluting the mixed acid hydrolyzate solution and precipitating cellodextrins by the addition of an organic solvent, e.g., by the addition of acetone in an amount equal to 9× the volume of the solution formed in the mixing step 102. Quenching by this method yields a white precipitate that may be isolated by filtration 108. Filtration 108 is optionally followed by washing 110 the filter cake with an additional quantity of organic solvent. The filter cake contains a purified mixture of cellodextrins that have not been further purified to isolate component fractions by cellodextrin type.

The filter cake is dissolved 112 by the addition of water, for example, using 15 liters of water per gram of cellulose to form a white cloudy solution. Separation 114, e.g., by centrifugation or filtration, produces a pellet 116 of insoluble longer cellodextrins and a clear solution 118 of shorter, soluble cellodextrins. The balance between longer and shorter cellodextrins in solution may be adjusted by the addition of water to solubilize longer cellodextrins or the reduction of water to leave longer cellodextrins in insoluble form. The pH of the solution 118 is frequently about 1.5. Residual acetone is evaporated 120 from solution 118 and the solution 118 is processed 122 by an ion exchange column to produce a clear solution 124 having a pH of about 2.5. The clear solution may be further processed at this stage by size exclusion chromatography to fractionate the cellodextrins by degree of polymerization. The pH is adjusted 126, e.g., by the addition of Ba(OH)₂ to achieve a pH of 7.0 and filtered 128 to remove solids, such as excess Ba(OH)₂. The remaining purified solution 130 is optionally freeze-dried 132 to produce a purified mixture of cello-oligosaccharides.

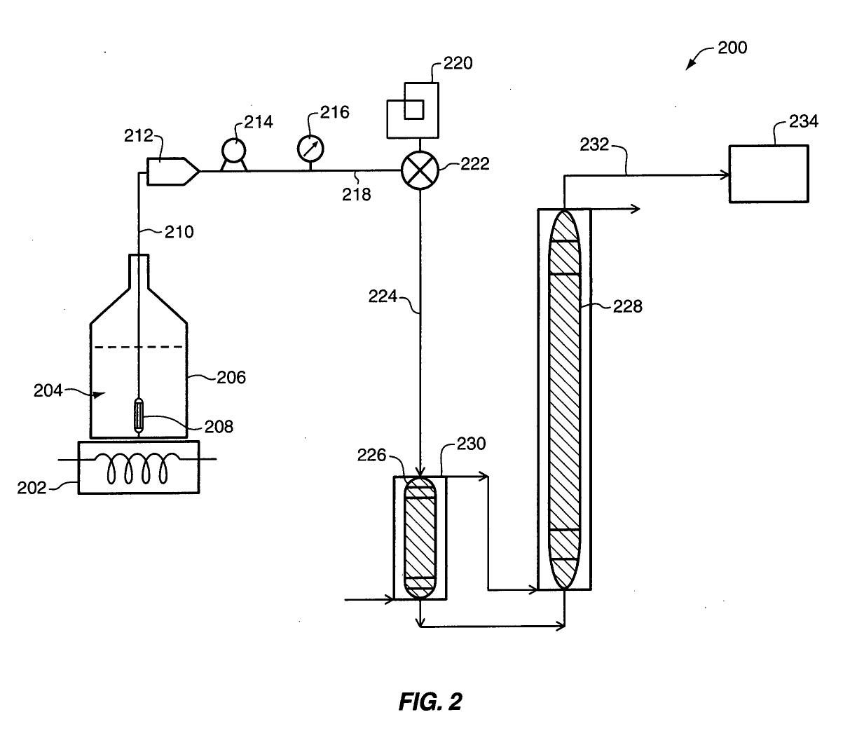

FIG. 2 shows a system 200 that can be used to purify mixed cellodextrins according to the process of FIG. 1 to separate the mixed cellodextrins into component fractions by cellodextrin type. A hot plate 202 is used to heat a cellodextrin solution 204 within reservoir 206 to assure solubility of cellodextrins in solution. A filter 208 prevents solids from entering line 210. A degasser 212 operates on a vacuum or separation principle to remove entrained air from solution 204 in line 210. A peristaltic pump 214 provides precise volumetric flow control and imparts motive force to convey solution 204 throughout equipment 200. A pressure gauge 216 provides process control information including the pressure in line 218. A superloop 220, for example, one that can be purchased from Amersham Biosciences of Piscataway, N.J., is used to add fluids to pressurized line 218. For example, buffer solutions or pH adjusting solutions may be added from superloop 220. A three way valve 222 may be used to selectively isolate flow in line 218 to permit flow from superloop 220, isolate superloop 220 to permit flow from line 218, or to isolate both superloop 220 and line 218. Line 224 delivers flow to an ion exchange resin column 226, such as a precolumn packed with Bio-Rad AG50WX4. A size exclusion column 228 contains a size exclusion resin or gel, such as Bio-Rad P4. A hot water jacket 230 circulates water at a predetermined temperature to facilitate the ion exchange process in the columns 226, 228. Purified cellodextrin solution exits the size exclusion column 228 through line 232 discharging into a fraction collector 234.

The overall flow rate though system 200, under control of peristaltic pump 214, may be timed to recover cellodextrin fractions based upon empirically observed residence times for flow of these fractions through size exclusion column 228. The recovery profile may be confirmed by spectroscopy, HPLC, or signal voltage measurements on eluent fractions collected by the fraction collector 234.

The following non-limiting examples identify preferred materials and methods for practicing the method of producing and separating cellodextrins. In these examples, all chemicals including cellotriose (G₃), cellotetraose (G₄) and cellopentose (G₅) were reagent grade chemicals purchased from Sigma of St. Louis, Mo., unless otherwise noted. Cellulose was purchased as Avicel™ PH105 from FMC Corp of Philadelphia, Pa.

### EXAMPLE 1

### Sugar Assay

Commercially acquired reagent grade cellodextrins were purchased for use as standard solutions. These solutions were chemically analyzed to confirm and calibrate cellodextrin concentration by liquid phase HPLC measurements. A Bio-Rad HPX87H column purchased from Bio-Rad, of Hercules, Calif. was operated at 55° C. with 0.01% (v/v) H₂SO₄ running buffer and a refractive index detector to confirm eluent peaks in the manner disclosed by Zhang, and Lind, Quantification of cell and cellulase mass concentrations during anaerobic cellulose fermentation: development of an ELISA-based method with application to Clostridium thermocellum batch cultures, Anal. Chem. 75: 219-227 (2003). A Waters 2696 HPLC device purchased from Waters Corporation of Milford, Mass. was joined with a Bio-Rad 42A column to measure cellodextrin concentrations (G₃-G₉) at a flowing rate of 0.4 mL/min distilled water and 80° C. with an injection volume of 10 μL, all in the3 manner disclosed by Gray et al., Sugar monomer and oligomer solubility: data and predictions for application to biomass hydrolysis, Appl. Biotechnol. Biochem. 105-108: 179-193 (2003). Because the Bio-Rad 42A column used a silver-cation exchange resin, it required that samples had neutral pH and not any Cl. Sample pH was neutralized by CaCO₃. Extra Cl⁻ in the sample was removed by adding AgNO₃ and centrifuging to remove the reaction product. Total soluble cellodextrin concentration was assayed by the phenol-sulfuric acid method with glucose as reference, in the manner taught by Lou et al., Cellobiose and cellodextrin metabolism by the ruminal bacterium Ruminococcus albus, Curr. Microbiol.35: 221-227 (1997).

Through the Bio-Rad 42A column assay, the Sigma standard cellotriose solution was found to contain some trace cellobiose. The cellotetraose standard included some G₃ and G₂. The cellopentose standard included G₂ to G₄. For example, Sigma cellopentose purity was calibrated to be 89%, very close to its labeled concentration of approximately 90%.

### EXAMPLE 2

### Cellodextrin Preparation

A mixture of cello-oligosaccharides was prepared according to the manner described in FIG. 1. Cellulose powder including twenty grams of Avicel (FMC PH105 or Sigmacell 20; microcrystalline cellulose) was mixed with 160 mL of ice-cooled concentrated HCl (˜37% aq) to provide a uniform suspension in 500 mL calibration flask. Forty mL of ice-cooled concentrated H₂SO₄ (98% aq) was added very slowly in several portions, under a fume hood, to form a mixed acid solution. The flask was sealed using a rubber stopper, and the solution was gently stirred usiong a magnetic bar mixer at about 22° C. for 4-6 hours. The solution was initially colorless solution, but slowly turned yellow over this interval until the color was a yellowish tan. The reaction was stopped by adding 900 mL of −20° C. acetone. A quantity of white precipitate appeared, and the solution was maintained at −20° C. for 2 hours. The mixture was filtered to remove residual cellulose using a Millipore AP40 glass fiber filter paper purchased from Millpore of Bedford, Mass. The white filtration cake was washed once using 300 mL of acetone. The wet filtration cake was dissolved in 300 mL of distilled water to form a cloudy white solution, and centrifuged to obtain a transparent soluble cellodextrin supernatant having a pH of about 1.5. The pellet contained longer cellodextrins having low solubility. The clear supernatant was left in the fume hood overnight to evaporate residual acetone.

The soluble cellodextrin solution was passed through a 2.2×10 cm anion-exchange column, namely, a Bio-Rad AGX80H column obtained from Bio-Rad of Richmond, Calif. To prepare the column, the anion exchange column was presoaked and saturated by cellobiose solution (cellodextrin may also be used) to prevent unwanted binding of cellodextrins. The cloumn was washed with a cellobiose solution to remove Cl⁻ from the column until no precipitae foprmed upon additon of AgNO₃. The hydrolyzate was passed rhough the colum to provide an eluent having a pH of 2.5. Ba(OH)₂ was mixed with the eluent to neutralize pH to 7.0 after anion exchange. BaSO₄ precipitate was removed using a 0.2 μm Nagene filter purchased from Nunc Internatinal Company of Rochchester, New Yor. The solution was left at room temperature overnight. Precipitate of BaSO₄ was removed through vacuum filtration by a 0.2 μm filter. The filtrate contained a nearly pure mixed cellodextrin solution, which was freeze-dried.

### EXAMPLE 3

### Kinetics of Cellulose Hydrolysis

A sensitivity study was performed by varying the concentration of mixed acids. The mixed acids containing commercially available concentrated HCl (˜37%) and concentrated H₂SO₄ (˜98%) were mixed in different ratios and used to hydrolyze cellulose. When H₂SO₄ was as high as 30% and the supplement was HCl, the cellodextrin solution turned black quickly, i.e., within 30 minutes. The black color indicated an undesirable oxidation of cellodextrins. When H₂SO₄ was lower than 20%, e.g., at 90:10 HCl to H₂SO₄ or 95:5, the cellulose hydrolysis process was very slow, exceeding twelve hours. Therefore, the preferred range for a mixture of concentrated HCl and H₂SO₄ acids is 10% to 30% (v/v) H₂SO₄. The composition of mixed HCl and H₂SO₄ (80:20; v/v) was an optimal ratio permitting quick cellulose hydrolysis without excessive oxidation. The foregoind reactons were performed at about 22° C. The optimal ratio may vary depending upon reaction conditions and the type of cellulose that is used.

With the optimal 80:20 mixture identified, cellulose powder including twenty grams of Avicel (FMC PH105 or Sigmacell 20) was mixed with 160 mL of ice-cooled concentrated HCl (36-38% aq) to provide a uniform suspension in a 500 mL calibration flask. A 40 mL quantity of ice-cooled concentrated H₂SO₄ (98% aq) was added very slowly in several portions under a hood. The flask was sealed using a rubber stopper and the solution was modestly stirred at room temperature for 4-7 hours. One mL of hydrolyzate sample was removed from the flask at one hour intervals and pipetted into 50 mL centrifuge tube which contained 1.3 gram of NaHCO₃ and less than 20 mL of distilled water. Solution volume was increased to 20 mL by adding distilled water. After centrifugation to separate the soluble cellodextrins from the insoluble cellodextrins, the supernatant was processed for a sugar assay in the manner described in Example 1 to determine saccharide content by fraction. Aliquots of the hydrolyzate were processed in this manner at hydrolysis times of 0, 1, 2, 3, 4, 5, and 6 hours.

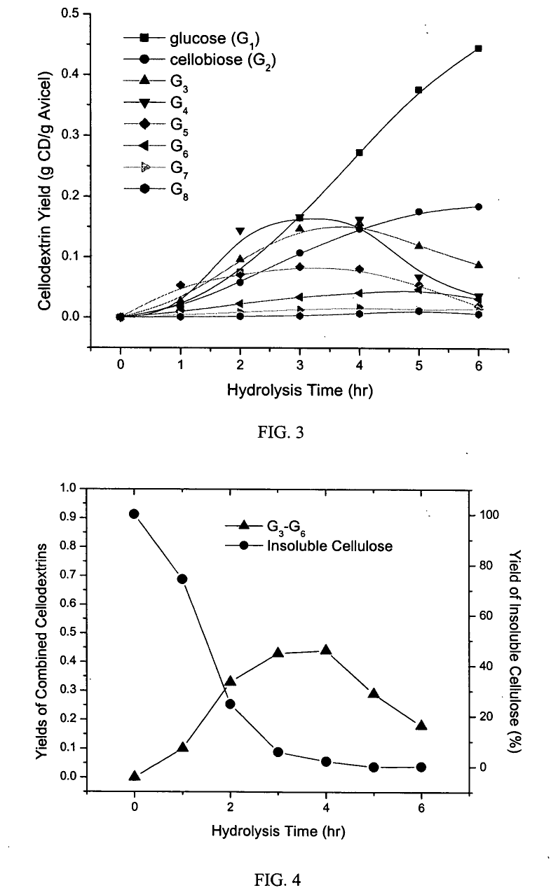

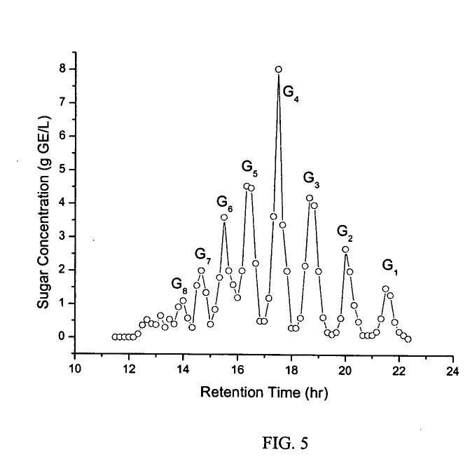

FIG. 3 shows the rate of hydrolysis of cellulose by mixed acids over the six hour hydrolysis period. Glucose and cellobiose concentration yields increased with time to become the dominant products (more than 50%) at the end of six-hour reaction. Cellotriose, cellotetraose and cellopentose had a maximum peak at around 4 hours and then decreased, while longer cellodextrins (G6-G9) had very low concentration always. FIG. 4 shows the same experimental results with the cellodextrins combined as groups including G₃-G₆ and insoluble cellulose and cellulose derivative in the aggregate. Nearly 95% of cellulose was converted to soluble sugar after two hours, 94% after three hours, and 98% complete hydrolysis was achieved after four hours, as shown in FIG. 4. The yields of combined cellodextrins G₂-G₈ and G₃-G₅ reached a maximum at about the fourth hour, being 0.614 and 0.4 g per gram of Avicel, respectively.

### EXAMPLE 4

### Resin Preparation, Column Packing and Cellodextrin Separation

This example shows various steps that may be taken to prepare cation exchange resin and cation exchange size exclusion resin for use in packing respective columns to purify the cellodextrin solution produced in Example 1.

A size exclusion column was packed using Bio-Gel P-4 (ultra-fine, <45 nm) purchased from Bio-Rad Laboratories of Hercules, Calif. Dry media was swollen by degassed water for 4 hours at room temperature. After hydration of the gel, the supernatant was decanted by suction to remove fine particles. Additional hydration and fines removal steps were repeated by adding degassed water, settling the resin, and suctioning to remove fines. Prior to packing the column, a ˜65% slurry was degassed under vacuum. A jacketed column having an internal diameter of 5 cm and a length of 100 cm was connected with a packing reservoir purchased form amersham Pharmacia Biscience of Piscataway, N.J. The column outlet was closed, and water was added to the bottom of the column. The even slurry was poured through a funnel into the column in a single movement. Splashing of the slurry was avoided to assure even packing and avoid entrapment of air bubbles. Upon formation of a settled bed 2-5 cm in length, the column was permitted to flow by a constant 50 cm water pressure until the whole column was packed. Thereafter, the packing reservoir was removed and a flow adaptor was fitted to theh column. Flow was restablished and increased in a linear gradient to a working flow rate of 1.5 mL/min. Iin order to obtain a close gel bed, the gel was packed again at a flow rate of 1.5 mL/min for 48 hours during which time the backpressue through the column ramped up linearly to about 15 to 20 psig. The final working length of P4 resin was 91 cm. A pulse consisting of 30 mL of 0.4 g/L vitamin B₁₂ was found to be diluted by a factor less than two, which indicated good column homogeneity.

A cation exchange resin column was packed using 700 grams of commercially available Bio-Rad AG 50W-X4 resin (ultra-fine, 400 mesh) Preparation of the resin began by mixing the resin with 2 L of 1 M HCl. The mixture was gently swirled to evenly distribute the resin for 4 hours. The mixture was gently decanted into a 4-L graduated cylinder. The resin had a yellow-white color and was allowed to settle. After settling, some fines were still suspended in the acid. The fines appeared as a film floating on the top of the liquid phase and as very finely dispersed dust-like particles suspended in the liquid. Fines were removed by siphoning all the liquid above the settled resin. Resin was suspended by adding distilled water. The resin was allowed to settle, and supernatant was removed by siphon. The step of washing with distilled water was repeated an additional three times to remove residual H⁺.

Following the washing of resin with water, the resin was gently swirled in 2 L of 0.25 mM CaCl₂ for 3 hours and allowed to settle. The supernatant was siphoned off. CaCl₂ washing was repeated a second time with a 2 liter volume of 0.5 M CaCl₂ solution, a third time with a 2 liter volume of 1 M CaCl₂ solution, and a fourth time with a 2 L volume of 1M CaCl₂ solution. Rather than decant the supernatant after the fourth time, the resin was heated from room temperature to 80° C. slowly and held here for 30 minutes. The solution stood for 3 to 4 hours until it cooled to room temperature. By this time the resin had settled, and it was possible to decant the calcium chloride solution. Several washes with distilled water were made to remove residual Ca²⁺ and ultra-fine or broken resin particles until the remaining resin particles were evenly spherical under microscopic observation. The mixture was added to a flask under vacuum at room temperature for packing the column. A jacketed column having a volume defined by a 5 cm internal diameter and 30 cm height was purchased as the model XK50 from Amersham Pharmacia Bioscience of Piscataway, N.J. Before adding resin, the column outlet was closed, and some distilled water was added at the bottom of column. With use of a funnel, the well-mixed and degassed resin suspension was added to the interior volume of the jacketed column. After the resin was added, the outlet at the bottom of the jacketed column was opened. The resin settled quickly at room temperature. The packing reservoir was removed, and a flow adaptor was added to a column inlet atop the jacketed column. Flow rate of distilled water was established at 45 mL/min by peristaltic pump for 1 hour. The flow adaptor was touched to the gel surface. The final length of cation exchange ion bed was 29 cm. Homogeneity of the cation ion exchange column was tested using 30 mL of 10 g/L blue dextran.

The first and second columns were connected in series and eluted in a downward-upward direction, as shown in FIG. 2, with the P4 resin being the last in series. A water bath was introduced to the jackets to increase the temperature in a gradual and slow manner to 65° C. at a flowing rate 1.5 mL/min. An undesirable rapid temperature increase could result in poor resolution and longer tail.

The scheme of cellodextrin separation was then practiced as shown in FIG. 2. Column temperature was increased gradually to 65° C. by use of the water jacket. The temperature of the columns was increased to 65° C. gradually at 5° C. per hour at a flow rate of 1.5 mL/min. A 30 mL of sample water was injected using a 50 mL-super loop plus 7-port valve (AP Bioscience, Piscataway, N.J.). Two and a half grams of freeze-dried cellodextrin powder were dissolved in 40 mL of distilled water, and then centrifuged to remove insoluble cellodextrins, and filtered through a 0.2 μm filter under vacuum. The distilled water mobile phase was heated to 80° C., and degassed through an in-line Waters degasser (Waters Co., Milford, Mass.). Separation of cellodextrins was carried out with a flow rate of 1.5 mL/min driven by a Masterflex pump, a column temperature of 65° C., and a pressure drop of about 15 psi. The effluent was fractionated into 15-mL volumes using a Foxy 200 fraction collector (Isco, Lincoln, Nebr.).

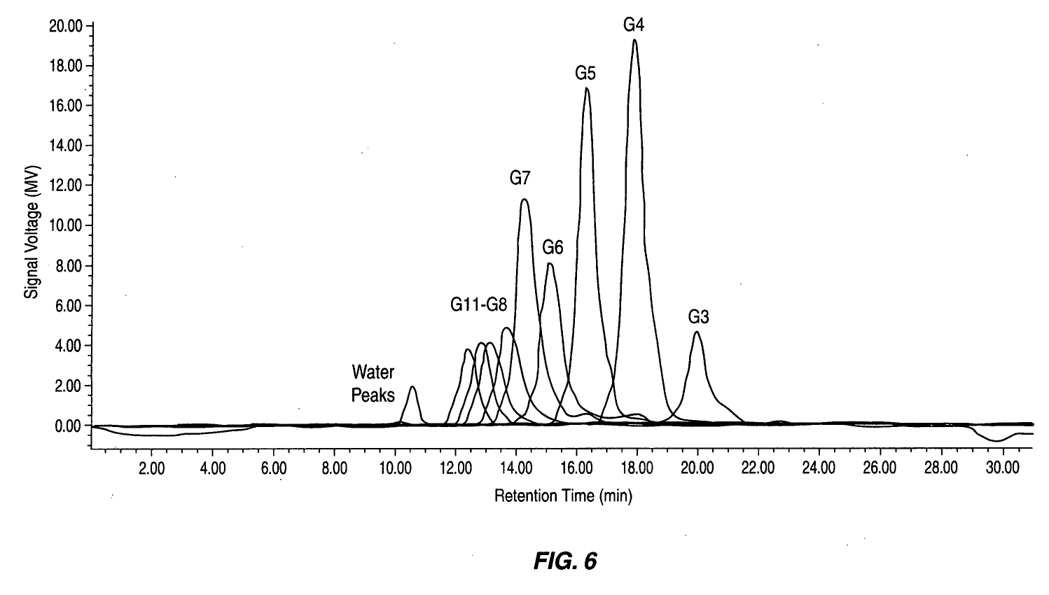

FIG. 6 shows the time-based concentration profiles of mixed cellodextrins separated by 30×5 I.D. cm cation exchange column followed by a 90×5 I.D. Bio-Rad P4 column. At the flowing rate of 1.5 mL/min, the entire separation required less than one day. Purified cellodextrins with DP from 3-11 are shown as an overlay in FIG. 6. Longer cellodextrins (DP≧6) have some trace amount of shorted cellodextrins (less than 98%). Table 1 shows that the productivities of four major pure soluble cellodextrins, cellotriose, cellotetraose, cellepentose and cellohexose were 185, 240 and 200, 100 mg/day, respectively. This separation system also obtained some longer cello-oligomers including G7-G11. Glucose was the only hydrolytic product of individual purified cellodextrins by acid hydrolysis (5% HCl, autoclave for 20 minutes) and cellulase plus β-glucosidase (not shown).

TABLE 1
Productivity Estimate

| | Cellodextrin Yield (g/g Avicel) | | |
|---|---|---|---|
| | Hydrolysis Time | | Productivity* |
| Sugar | 4 Hours | 5.5 Hours | (mg/Day |
| Glucose (G₁) | 0.007 | 0.021 | NA |
| Cellobiose (G₂) | 0.025 | 0.042 | NA |
| Cellotriose (G₃) | 0.040 | 0.065 | 185 |
| Cellotetraose (G₄) | 0.065 | 0.078 | 240 |
| Cellopentose (G₅) | 0.061 | 0.062 | 200 |
| Cellohexose (G₆) | 0.023 | 0.019 | 100 |
| Celloheptose (G₇) | 0.008 | 0.007 | 50 |
| G₈ | 0.003 | 0.002 | 20 |
| G₉ | 0.002 | 0.001 | 8 |
| G₁₀-Gn | trace | trace | trace |

*0.30 mL mixed cellodextrins (˜40 g/L sugar) was applied to the separation columns.

### EXAMPLE 5

### Comparative Hydrolysis by H₂SO₄ HCl

Tests were performed to ascertain whether cellulose can be efficiently dissolved by H₂SO₄ alone at concentrations of 64%, 72%, 80% and 88%. Results showed that 1 g of Avicel (FMC PH-105) can be completely dissolved by 10 ML of sulfuric acid solution (≧72%) but not 64% sulfuric acid. The dissolved cellulose solutions were initially clear, but could quickly turn black, a color indicating undesirable oxidation of the cellodextrins. Concentrations of 80% and 88% sulfuric acid required less than one half hour to turn black. Using 72% sulfuric acid, cellulose was first hydrolyzed cellulose at room temperature for a half hour. Acid concentration was then diluted 3-fold diluted by the addition of water, and the solution was heated for another half hour to obtain a yellow transparent solution containing cellodextrins. There remained the problem of neutralizing pH. It might be expected that Ba(OH)₂ addition would neutralize sulfuric acid and remove sulfate at the same step; however, high concentrations of BaSO₄ sufficient to neutralize pH also remove cellodextrins by an occlusion effect, which results in unacceptably low yield of cellodextrins.

Cellulose hydrolysis by fuming HCl, as taught by Miller (1963), is the most widely used conventional approach for hydrolyzing cellulose to cellodextrins. Various references report that an HCl concentration of greater than 40% (p=1.20) is required for cellulose dissolution, e.g., Jayme et al., Cellulose solvents. Methods in Carbohydrate Chemistry (1963), although, sometimes a less concentrated HCl (ρ=1.18) is used to dissolve cellulose at −30° C. as shown by Halliwel et al. (1981). In current experiments, 37.4% HCl mixed with Avicel required more than 12 hours at 28° C. were required to dissolve the Avicel. In practice, the cellodextrin distribution by such digestion is difficult to reproduce because of the unpleasant character of HCl solutions, and limitations preventing control of experimental conditions.

### EXAMPLE 6

### Solvents

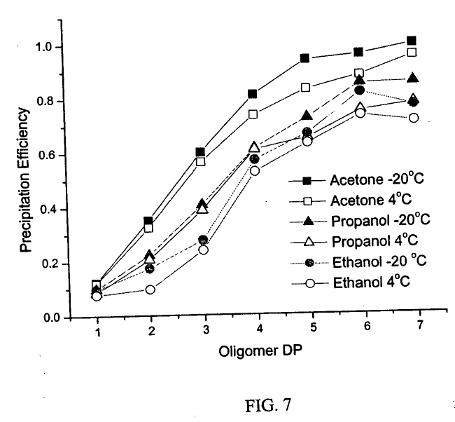

In Miller's 1963 method, hydrolyzate is neutralized by NaHCO₃; however, a desalting step follows neutralization. Organic solvents have been used to precipitate cellodextrins without NaHCO₃ acid neutralization, in order to avoid the desalting step. Various organic solvents were used for this purpose to ascertain whether precipitation by organic solvent is also effective in the case of mixed acid hydrolysis. The solvents included ethanol, propanol, and acetone. Cellodextrin precipitation efficiency by ethanol, propanol and acetone was investigated at a cellodextrin/organic solvent ratio of 1:9 (v/v). FIG. 7 shows that precipitation efficiencies increased greatly from nearly zero to nearly one with an increase in sugar DP. Acetone was the most efficient organic solvent compared to propanol and ethanol. Reducing the temperature from 4° C. to −20° C. improved precipitation efficiency by about 10% to 20%, especially for shorter cellodextrins. Through acetone precipitation, most acids, glucose and cellobiose, as well as about half of the cellotriose were left in the liquid phase; while longer cellodextrins were settled down in the solid phase.

Precipitation of cellodextrins in organic solvents is a convenient method to remove most of the acid used for hydrolysis prior to cellodextrin separation. The fraction of cellodextrins removed by precipitation (precipitation efficiency) is a function of the degree of polymerization (DP), the solvent used, and the precipitation temperature. As may be seen from FIG. 7, precipitation efficiency increased with increasing DP and was at least 0.6 for DP ≧3 at −20° C. Precipitation with acetone resulted in slightly higher efficiencies as compared to precipitation with 2-propanol, and was higher by a larger margin as compared to precipitation with ethanol. The precipitation efficiency was higher at −20° C. as compared to 4° C. regardless of DP.

Yields of individual cellodextrins after hydrolysis for either 4 or 5.5 hours followed by acetone precipitation are shown in Table 1. The aggregate G₃ to G₆ yield is 190 mg/g Avicel at 4 hours and 224 mg/g at 5.5 hours. As expected, cellotriose yields are higher and cellohexose yields are lower at the 5.5 hour incubation time as compared to 4 hours. Precipitated hydrolyzate preparations contained 70 to 80% cellodextrins on a mass basis as determined by HPLC (data not shown).

There were 20-30% impurities in crude mixed cellodextrins, which might include residual Cl⁻, sulfate, Ba²⁺, acetone and cellulose sulfate. But those impurities can be removed easily during separation. Table 1 shows yields of individual cellodextrins after 4 and 5.5 hours of hydrolysis. It was apparent that longer reaction time resulted in more shorter cellodextrins and fewer longer cellodextrins. But the combined yields of major cellodextrins (G₃-G₆) were nearly constant (190 mg/g and 224 mg/g) vs. time, indicating easily-controlled reaction. A greater cellodextrin yield may be obtained by using additional distilled water to dissolve precipitate.

### REFERENCES

The following documents are incorporated herein by reference:

B. G. Guimaraes, H. Souchon, B. L. Lytle, J. H. D. Wu, P. M. Alzaro, The crystal structure of catalytic mechanism of cellobiohydrolase CelS, the major enzymatic component of the Clostridium thermocellum cellulosome. J. Mol. Biol. 320 (2002) 587-596.

J. Rouvinen, T. Bergfors, T. Teeri, J. K. C. Knowles, T. A. Jones, Three-dimensional structure of cellobiohydrolase II from Trichoderma reesei. Science 249 (1990) 380-385.

U. Fauth, M. P. M. Romaniec, T. Kobayashi, A. L. Demain, Purification and characterization of endoglucanase Ss from Clostridium thermocellum. Biochem. J. 279 (1991) 67-73

T.-A. Hsu, C.-S. Gong, G.-T. Tsao, Kinetics studies of cellodextrins hydrolyses by exocellulase from Trichoderma reesei. Biotechnol. Bioeng. 22 (1980) 2305-2320.

G. Halliwell, R. Vincent, The action on cellulose and its derivates of a purified 1,4-β-glucanase from Trichoderma koningii. Biochem. J. 199 (1981) 409-417.

S. Bhat, P. W. Goodenough, E. Owen, M. K. Bhat, Cellobiose: a true inducer of cellulosome in different strains of Clostridium thermocellum. FEMS Microbiol. Lett. 111 (1993) 73-78.

N. A. Spiridonov, D. B. Wilson, Regulation of biosynthesis of individual cellulases in Thermomonospora fusca. J. Bacteriol.180 (1998) 3549-3552.

S. N. Freer, R. W. Detroy, Direct fermentation of cellodextrins to ethanol by Candida wickerhamii and C. lusitaniae. Biotechnol. Lett. 4 (1982) 453-458.

S. N. Freer, R. W. Detroy, Characterization of cellobiose fermentations to ethanol by yeasts. Biotechnol. Bioeng. 25 (1983) 541-557.

J. B. Russell, Fermentation of cellodextrins by cellulolytic and noncellulolytic rumen bacteria. Appl. Environ. Microbiol. 49 (1985) 572-576.

Y. Shi, P. J. Weimer, Utilization of individual cellodextrins by three predominant ruminal cellulolytic bacteria. Appl. Envrion. Microbiol. 62 (1996) 1084-1088.

J. Lou, K. A. Dawson, H. J. Strobel, Cellobiose and cellodextrin metabolism by the ruminal bacterium Ruminococcus albus. Curr. Microbiol.35 (1997) 221

H. J. Strobel, F. C. Caldwell, K. A. Dawson, Carbohydrate transport by the anaerobic thermophile Clostridium thermocellum. Appl. Environ. Microbiol. 61, (1995) 4012-4017.

S. Wakabayashi, Y. Kishimoto, A. Matsuoka, Effect of indigestive dextrin on glucose tolerance in rats. J. Endocrinology.144 (1995) 533-538.

J. H. Cummings, G. T. Macfarlane, Role of intestinal bacteria in nutrient metabolism. Clinic Nutr.16 (1997) 3-11.

G. L. Miller, J. Dean, R. Blum, A study of methods for preparation oligosaccharides from cellulose. Arch. Biochem. Biophy. 91 (1960) 21-26.

G. L. Miller, Cellodextrins. Methods Carbohydrate Chem. 3 (1963) 134

A. Huebner, M. R. Ladisch, G. T. Tsao, Preparation of cellodextrin: an engineering approach. Biotechnol. Bioeng. 20 (1978)1669-1677

G. Schmid, M. Bisell, C. Wandrey, Preparation of cellodextrins and isolation of oligomeric side components and their characterization. Anal. Biochem. 175 (1988) 573-583.

M. Voloch, M. R. Ladisch, M. Cantarlla, G. T. Tsao, Preparation of cellodextrins using sulfuric acid. Biotechnol. Bioeng.26 (1984) 557-559.

E. E. Dickey, M. L. Wolform, A polymer-homologous series of sugar acetates from the acetolysis of cellulose. J. Am. Chem. Soc.71 (1949) 825-828.

M. L. Wolfram, J. C. Dacons, The polymer-homogous series of oligosacchardies from cellulose. J. Am. Chem. Soc. 74 (1952) 5331-5333.

K. Hamacher, G. Schmid, H. Sham, C. H. Wandrey, Structural heterogeneity of cellooligomers homogeneous according to high-resolution size-exclusion chromatography. J. Chromatogr. 319 (1985) 311-318.

M. John, J. Schmidt, C. Wandrey, H. Sahm. Gel Chromatography of oligosaccharides up to DP 60. J. Chromatogr.247 (1982) 281-288.

M. John, H. Dellweg, Chromatographuc separation of oligosaccharides. Seperation Purification. Method. 2 (1973) 231-257.

M. R. Ladisch, A. L. Huebner, G. T. Tsao, High-speed liquid chromatography of cellodextrins and other saccharide mixtures using water as the eluent. J. Chromatoghaphyl47 (1978) 185-193.

Y. H. Zhang, L. R. Lynd, Quantification of cell and cellulase mass concentrations during anaerobic cellulose fermentation: development of an ELISA-based method with application to Clostridium thermocellum batch cultures. Anal. Chem. 75 (2003) 219-227.

M. C. Gray, A. O. Converse, C. E. Wyman, Sugar monomer and oligomer solubility: data and predictions for application to biomass hydrolysis. Appl. Biotechnol. Biochem. 105-108 (2003) 179-193.

G. Jayme, F. Lang, Cellulose solvents. Methods in Carbohydrate Chemistry. 3 (1963) 75-83.

A. N. Pereira, M. Mobedshahi, M. R. Ladisch, Preparation of cellodextrins. Methods Enzymol.160 (1988) 26-38.

T. D. Bartley, K. Murphy-Holland, D. E. Eveleigh, A method for the detection and differentiation of cellulase components in polyacrylamide gels. Anal. Biochem. 140 (1984) 157-161.

D. Klemm, B. Philipp, T. Heinze, U. Heinze, W. Wagenknecht. Comprehensive Cellulose Chemistry 2: Functionalization of Cellulose. (1998) Wiley-VCH, Weinheim.

We claim:

1. A method of purifying cellodextrins, the method comprising steps of:
dissolving cellulose with a mixture of acids including hydrochloric acid and sulfuric acid to form a hydrolyzate solution that contains cellodextrins; and
adding an organic solvent to the hydrolyzate solution to precipitate the cellodextrins from the hydrolyzate solution.

2 The method of claim 1, wherein the step of dissolving cellulose utilizes concentrated hydrochloric acid and concentrated sulfuric acid in the mixture of acids.

3. The method of claim 2, wherein the step of dissolving cellulose comprises mixing the concentrated hydrochloric acid and the concentrated sulfuric acid in a molar ratio ranging from 3:1 to 5:1 hydrochloric acid to sulfuric acid.

4. The method of claim 2, wherein the step of dissolving cellulose comprises mixing the concentrated hydrochloric acid and the concentrated sulfuric acid in a molar ratio of 4:1 hydrochloric acid to sulfuric acid.

5. The method of claim 1, wherein the step of dissolving cellulose comprises mixing the hydrochloric acid and the sulfuric acid in a molar ratio ranging from 3:1 to 5:1 hydrochloric acid to sulfuric acid.

6. The method of claim 1, wherein the step of dissolving cellulose comprises mixing the hydrochloric acid and the sulfuric acid in a molar ratio of 4:1 hydrochloric acid to sulfuric acid.

7. The method of claim 1, wherein the mixture of acids used in the step of dissolving cellulose comprises effective amounts the acids to dissolve at least 0.1 mg cellulose per mL of the mixture of acids.

8. The method of claim 1, wherein the organic solvent used in the step of adding the organic solvent comprises acetone.

9. The method of claim 1, further comprising a step of removing the precipitate from the mixture of acids.

10. The method of claim 9, wherein the step of removing the precipitate comprises filtering the precipitate to form a filter cake.

11. The method of claim 9, wherein the step of removing the precipitate comprises centrifuging the precipitate to form a pellet.

12. The method of claim 9, further comprising
resuspending the cellodextrins in a second solution; and
purifying the cellodextrins by ion exchange.

13. The method of claim 12, wherein the step of resuspending the cellodextrins comprises mixing the cellodextrins with water.

14. A system for purifying cellodextrins, comprising:
a hydrolyzate solution including cellulose dissolved by a mixture of acids that contains hydrochloric acid and sulfuric acid;
means for adding an organic solvent to the hydrolyzate solution to precipitate cellodextrins from the hydrolyzate solution;
means for removing cellodextrin precipitate from the hydrolyzate solution;
means for resuspending the cellodextrin precipitate in a second solution; and
an ion exchange device configured to purify the cellodextrins by ion exchange.

15. The system of claim 14, wherein the hydrolyzate solution contains concentrated hydrochloric acid and concentrated sulfuric acid.

16. The system of claim 15, wherein the hydrolyzate solution contains the concentrated hydrochloric acid and the concentrated sulfuric acid in a molar ratio ranging from 3:1 to 5:1 hydrochloric acid to sulfuric acid.

17. The system of claim 15, wherein the hydrolyzate solution contains the concentrated hydrochloric acid and the concentrated sulfuric acid in a molar ratio of 4:1 hydrochloric acid to sulfuric acid.

18. The system of claim 14, wherein the hydrolyzate solution comprises effective amounts of the acids for dissolving at least 0.1 mg cellulose per mL of the mixture of acids.

19. The system of claim 14, wherein the means for adding an organic solvent comprises acetone as the organic solvent.
